(19) United States
(12) Patent Application Publication
(10) Pub. No.: US 2015/0193755 A1
(43) Pub. Date: Jul. 9, 2015

(54) POINT-OF-SALE COMMUNICATION AND PAYMENT SYSTEM

(71) Applicant: Pay(Q)R, LLC, Strongsville, OH (US)

(72) Inventor: George Sibble, San Francisco, CA (US)

(73) Assignee: Pay(Q)R, LLC, Strongsville, OH (US)

(21) Appl. No.: 14/149,098

(22) Filed: Jan. 7, 2014

(51) Int. Cl. G06Q 20/20; G06Q 20/32

(52) U.S. Cl. CPC G06Q 20/202; G06Q 20/322; G06Q 20/325

(57) ABSTRACT

Embodiments may relate to a cloud-based messaging system for making mobile payments for retail purchases. Some embodiments may include a plurality of networked computers defining an access layer which may operate on a predetermined platform. The access layer may be adapted to receive messages from at least one remote server performing subscription verification functions, and route the messages to predetermined point-of-sale computers. The access layer may be further adapted to receive messages from the predetermined point-of-sale computers and route the messages to at least one consumer-side application through the at least one remote server. The point-of-sale computers may include a client application adapted to receive messages through the messaging system of the access layer, take actions in response to the messages received, and send messages through the messaging system of the access layer to the consumer-side application.

### I. BACKGROUND OF THE INVENTION

A. Field of Invention

Some embodiments may generally relate to mobile payment devices, systems and/or methods.

B. Description of the Related Art

Means for rendering payment from mobile devices are known in the computing and e-commerce arts; however, known methods and systems have a number of drawbacks. Namely, many known systems require that a given point-of-sale cash register computer system and remote mobile computing device must communicate in a synchronous rather than asynchronous mode. This is significant because synchronous communications require two communicating devices to form a connection, for instance, through a handshake and/or by sharing a common clock signal. Such requirements inherently limit the capacity of a point-of-sale system to communicate with a large number of remote devices because it must form connections with each device. Furthermore, many known systems also require the use of databases to store data related to a transaction on the point-of-sale computer, the mobile device, intermediate servers, or all three; and, may further require synchronization of these databases. Such architectures inherently degrade security by replicating payment credentials in multiple locations, some of which may be easily accessible, such as a mobile computing device.

What is needed is a system that allows mobile devices to communicate asynchronously with point-of-sale systems and eliminates the need for multiple synchronized databases. Some embodiments of the present invention may provide one or more benefits or advantages over the prior art.

### II. SUMMARY OF THE INVENTION

Some embodiments may relate to a remote point-of-sale communication and payment system, comprising: at least one application executable on a mobile computing device, wherein the at least one application is adapted to generate messages to selected remote point-of-sale computers, receive messages from the selected remote point-of-sale computers, and generate orders to transmit payment credentials to the selected remote point-of-sale computers; at least one remote server adapted to receive the messages from the at least one application and relay the messages to a cloud-based messaging system, the at least one remote server being further adapted to receive the messages from the selected remote point-of-sale computers through the cloud-based messaging system and relay the messages to the at least one application; and the at least one remote server being still further adapted to receive payment orders from the at least one application and transmit corresponding payment credentials to the selected point-of-sale computers as messages through the cloud-based messaging system; the cloud-based messaging system comprising: a plurality of networked computers defining an access layer operating on a predetermined platform, the access layer being adapted to receive messages from the at least one remote server and route the messages to predetermined point-of-sale computers, and the access layer being further adapted to receive messages from the predetermined point-of-sale computers and route the messages to the at least one application through the at least one remote server; and the at least one remote point-of-sale computer including a point-of-sale client executable on the at least one point-of-sale computer, the point-of-sale client being adapted to receive messages through the messaging system of the access layer, take actions in response to the messages received, and send messages through the messaging system of the access layer to the at least one application.

According to some embodiments the at least one remote server comprises a plurality of remote servers each operating on arbitrary platforms.

According to some embodiments the cloud-based messaging system further comprises a set of server libraries adapted to enable communications between each of the plurality of remote servers operating on arbitrary platforms and the access layer operating on a predetermined platform.

Embodiments may also include an application programming interface, wherein the at least one remote server is adapted to communicate with the at least one application through the application programming interface.

According to some embodiments the at least one remote server further comprises a customer database containing one or more of customer-identifying information, customer payment credentials, customer subscription information, or system usage information of a user.

According to some embodiments the cloud-based messaging system comprises a pub/sub messaging system adapted to publish messages to one or more predetermined channels, and the cloud-based messaging system being further adapted to enable the access layer and/or the at least one point-of-sale client to subscribe to the one or more predetermined channels.

According to some embodiments the cloud-based messaging system routes addressed messages to predetermined addressee recipients.

According to some embodiments the at least one point-of-sale client further comprises a cash register program adapted to interact with and communicate with the access layer through the messaging system.

According to some embodiments the at least one point-of-sale client is adapted to receive messages from the access layer, translate the messages into a form readable by the cash register program, and transmit the messages to the cash register program; and the point-of-sale client being further adapted to receive messages from the cash register program, translate the messages into a form readable by the access layer, and transmit the messages to the access layer.

Some embodiments may relate to a remote point-of-sale communication and payment system, comprising: a cloud-based messaging system comprising: a plurality of networked computers defining an access layer operating on a predetermined platform, the access layer being adapted to receive messages from at least one remote server and route the messages to predetermined point-of-sale computers, and the access layer being further adapted to receive messages from the predetermined point-of-sale computers and route the messages to at least one consumer-side application through the at least one remote server; and the at least one remote point-of-sale computer including a point-of-sale client executable on the at least one point-of-sale computer, the point-of-sale client being adapted to receive messages through the messaging system of the access layer, take actions in response to the messages received, and send messages through the messaging system of the access layer to the at least one consumer-side application.

According to some embodiments the cloud-based messaging system further comprises a set of server libraries adapted to enable communications between the access layer and each of the plurality of remote servers, wherein the remote servers each operate on arbitrary platforms and the access layer operates on a predetermined platform.

According to some embodiments the cloud-based messaging system comprises a pub/sub messaging system adapted to publish messages to one or more predetermined channels, and the cloud-based messaging system being further adapted to enable the access layer and/or the at least one point-of-sale client to subscribe to the one or more predetermined channels.

According to some embodiments the cloud-based messaging system routes addressed messages to predetermined addressee recipients.

According to some embodiments the at least one point-of-sale client further comprises a cash register program adapted to interact with and communicate with the access layer through the messaging system.

According to some embodiments the at least one point-of-sale client is adapted to receive messages from the access layer, translate the messages into a form readable by the cash register program, and transmit the messages to the cash register program; and the point-of-sale client being further adapted to receive messages from the cash register program, translate the messages into a form readable by the access layer, and transmit the messages to the access layer.

Some embodiments may relate to a remote point-of-sale communication and payment system, comprising: at least one application executable on a mobile computing device, wherein the at least one application is adapted to generate messages to selected remote point-of-sale computers, receive messages from the selected remote point-of-sale computers, and generate orders to transmit payment credentials to the selected remote point-of-sale computers; at least one remote server adapted to receive the messages from the at least one application and relay the messages to a cloud-based messaging system, the at least one remote server being further adapted to receive the messages from the selected remote point-of-sale computers through the cloud-based messaging system and relay the messages to the at least one application; and, the at least one remote server being still further adapted to receive payment orders from the at least one application and transmit corresponding payment credentials to the selected point-of-sale computers as messages through the cloud-based messaging system, wherein the at least one remote server comprises a plurality of remote servers each operating on arbitrary platforms, and wherein the cloud-based messaging system further comprises a set of server libraries adapted to enable communications between each of the plurality of remote servers operating on arbitrary platforms and the access layer operating on a predetermined platform; an application programming interface, wherein the at least one remote server is adapted to communicate with the at least one application through the application programming interface; the cloud-based messaging system comprising: a plurality of networked computers defining an access layer operating on a predetermined platform, the access layer being adapted to receive messages from the at least one remote server and route the messages to predetermined point-of-sale computers, and the access layer being further adapted to receive messages from the predetermined point-of-sale computers and route the messages to the at least one application through the at least one remote server; and the at least one remote point-of-sale computer including a point-of-sale client executable on the at least one point-of-sale computer, the point-of-sale client being adapted to receive messages through the messaging system of the access layer, take actions in response to the messages received, and send messages through the messaging system of the access layer to the at least one application.

According to some embodiments the cloud-based messaging system comprises a pub/sub messaging system adapted to publish messages to one or more predetermined channels, and the cloud-based messaging system being further adapted to enable the access layer and/or the at least one point-of-sale client to subscribe to the one or more predetermined channels.

According to some embodiments the cloud-based messaging system routes addressed messages to predetermined addressee recipients.

According to some embodiments the at least one point-of-sale client further comprises a cash register program adapted to interact with and communicate with the access layer through the messaging system.

According to some embodiments the at least one point-of-sale client is adapted to receive messages from the access layer, translate the messages into a form readable by the cash register program, and transmit the messages to the cash register program; and the point-of-sale client being further adapted to receive messages from the cash register program, translate the messages into a form readable by the access layer, and transmit the messages to the access layer.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a schematic diagram of an embodiment including a mobile computing device, a set of remote servers, a cloud-based access layer and messaging system, and a point-of-sale checkout system;

FIG. 2 is a schematic diagram showing a set of remote servers directly integrated with the cloud-based access layer and messaging system;

FIG. 3 is a schematic diagram showing a portion of a set of remote servers being licensee servers which communicate with an access layer through one or more server libraries;

FIG. 4 is a schematic diagram showing a mobile computing device communicating with one or more remote servers through an application programming interface (API);

FIG. 5 is a schematic diagram showing an embodiment implementing an in-memory caching system;

FIG. 6 is a schematic diagram showing an embodiment implementing a pub/sub messaging system;

FIG. 7 is a schematic diagram showing an embodiment implementing an addressed messaging system;

FIG. 8 is a schematic diagram showing a consumer frontend of an embodiment; and

FIG. 9 is a schematic diagram illustrating the operation of a consumer frontend at a plurality of establishments simultaneously.

### IV. DETAILED DESCRIPTION OF THE INVENTION

Embodiments may enable consumers to place orders, receive information about orders, and/or pay for orders from a mobile computing device. In general, embodiments of the invention may include a cloud-based messaging system adapted to receive requests for information and payment orders in the form of messages from consumers, and route the messages to a point-of-sale computer system. The point-of-sale system may comprise a cash register or similar retail check-out computing device. The cloud-based messaging system may also be adapted to receive messages from the point-of-sale computer system and route the messages to consumers.

According to some embodiments a cloud-based messaging system can comprise a plurality of networked computers forming or defining an access layer. The computers of the access layer may operate on any of a variety of known hardware and software platforms, and may communicate with each other using a wide variety of known protocols. Accordingly, one skilled in the art will appreciate that platform selection will ordinarily be consistent across the entire access layer; however, consistency is not required.

A wide variety of messaging systems and system topologies may be appropriate depending on the specific embodiment. For instance, in one embodiment a publish-subscribe (i.e. pub/sub) messaging system may be advantageous, whereas in another embodiment it may be preferable to address messages according to the intended recipient. With particular regard to pub/sub systems, a plurality of computing devices may communicate with each other by publishing messages to a selected cloud-based channel to which other computers may subscribe. Subscribed computers listen for messages published to the channel and either download them as they are published or receive pushed messages from the channel. Thus, pub/sub systems eliminate wasting computer resource on polling to check for new content. Alternatively, some embodiments may address messages to specified recipients. For instance, a message may be addressed to an IP address, a user at an IP address (e.g. an email address), a MAC address, or another unique identifier. In contrast to a pub/sub system, only the addressee receives an addressed message.

To illustrate how a messaging system may operate according to embodiments of the invention, an access layer may receive a message from a consumer which is directed to a particular point-of-sale computer system. The message may for instance be a request for information about a product for sale, a request to place the product in an e-commerce shopping cart, and/or an order to direct payment to the point-of-sale computer system. Regardless of the nature of the message, the access layer would either publish the message to a channel to which the point-of-sale system is subscribed, or the access layer relays the message to a particular point-of-sale system based on an address contained in the message. In the case of a pub/sub system, the point-of-sale computer system may receive an indication that a new message is available to which it responds by downloading the message, or it may receive the message according to a push protocol. Having received the consumer's message, the point-of-sale system may then act upon it. For instance, the point-of-sale computer may return requested data to the consumer, or it may process a payment using credentials provided by the consumer or the consumer's agent.

In some embodiments the point-of-sale system may be a pre-existing system which must be adapted to communicate with a messaging system of an embodiment. In such cases, the pre-existing system likely includes a cash register program or similar retail checkout software, which is adapted to communicate according to protocols which are incompatible with the access layer. Thus, a point-of-sale client program may be installed on the point-of-sale computer system. The client program may be adapted to communicate with the access layer through the cloud-based messaging system and translate messages from the access layer into a form readable by the point-of-sale computer system. Similarly, the client program may translate communications from the point-of-sale system into messages which are compatible with the access layer and/or with downstream computer systems such as consumer mobile applications.

In other embodiments, the point-of-sale system may comprise a retail checkout system already adapted to communicate with the access layer through the messaging system. Accordingly, such systems would not require an additional point-of-sale client because the point-of-sale computer system would already be suitably programmed to communicate with the access layer.

Turning to the consumer side, a consumer may interact with an embodiment from a mobile computing device such as, without limitation, a smart phone app or a tablet computer app, which may be adapted to interact with a mobile payment service provider's remote server through, for instance, an Internet connection. The remote server may function as a layer where subscription status is verified, and/or where payment credentials are stored. If a system attempting to access the remote server is verified as a current subscriber, then access may be granted and its messages may be passed to the access layer. In some embodiments, the service provider's remote server may be directly integrated with the access layer and may exist in the same cloud-based system as the access layer. Thus, a consumer may interact with a single cloud-based computer, or system of computers, to conduct subscription functions and to pass messages to the access layer. Alternatively, the service provider's remote server may not be directly integrated with the access layer, may be separately located, may have its own security credentials for communicating with the access layer, and/or may communicate with the access layer through, for instance, an Internet connection. Furthermore, such non-integrated remote servers may operate on arbitrary platforms which are not necessarily compatible with the access layer. Thus, the access layer may also include a server library to allow incompatible platforms to interact with the access layer.

One reason that the plurality of remote servers may operate on arbitrary platforms rather than a known predetermined platform is that they may be owned and operated by different mobile payment service providers. For example, a single tier-one entity may own and operate the access layer, the cloud-based messaging system, and even one or more remote servers which may or may not be integrated with the access layer, but a plurality of tier-two entities may subscribe to use tier-one infrastructure. According to this model, the tier-two entities may each have their own subscribers and their own proprietary consumer-side interfaces, such as mobile apps; however, the tier-two entities subscribe to use the tier-one's infrastructure to process their subscribers' mobile payments. Furthermore, tier-two entities may link to and interact with tier-one infrastructure with little or no reprogramming of their systems being necessary.

Embodiments may include a consumer-side frontend with certain novel adaptations. In general, a consumer frontend may enable a user to place and pay for orders at, for instance a bar, restaurant, hotel or other hospitality establishment. However, they may also enable consumers to hold open a plurality of tabs at unrelated establishments, and may further allow the user to close and/or pay the tabs selectively or all at once. Furthermore, frontends according to embodiments of the invention may include geofencing features, which may be used for pushing offers and/or advertisements to the consumer, and may also be used to trigger automatic checkout if the consumer leaves the establishment without paying or requesting to hold open his tab. Still further, embodiments may include means for enabling consumers not physically located at the establishment to join a bill and pay at least a portion thereof. Such features may be especially helpful to groups of people visiting a plurality of establishments who may or may not enter and leave together.

A consumer-side frontend may include a graphical user interface (GUI) adapted for use with a touch screen device. The GUI may include one or more graphical buttons or other graphical controls which may be used alone or in combination to create and send messages to a remote server. Thus, touch-interaction by a user with the control(s) of the GUI may cause the frontend to create and transmit a message to a remote server. The messages may include without limitation payment orders, and/or requests for information such as lists of items purchased or available for purchase. For example, a GUI may include a “Pay Now” button adapted to transmit a message comprising a payment order when a user actuates the button.

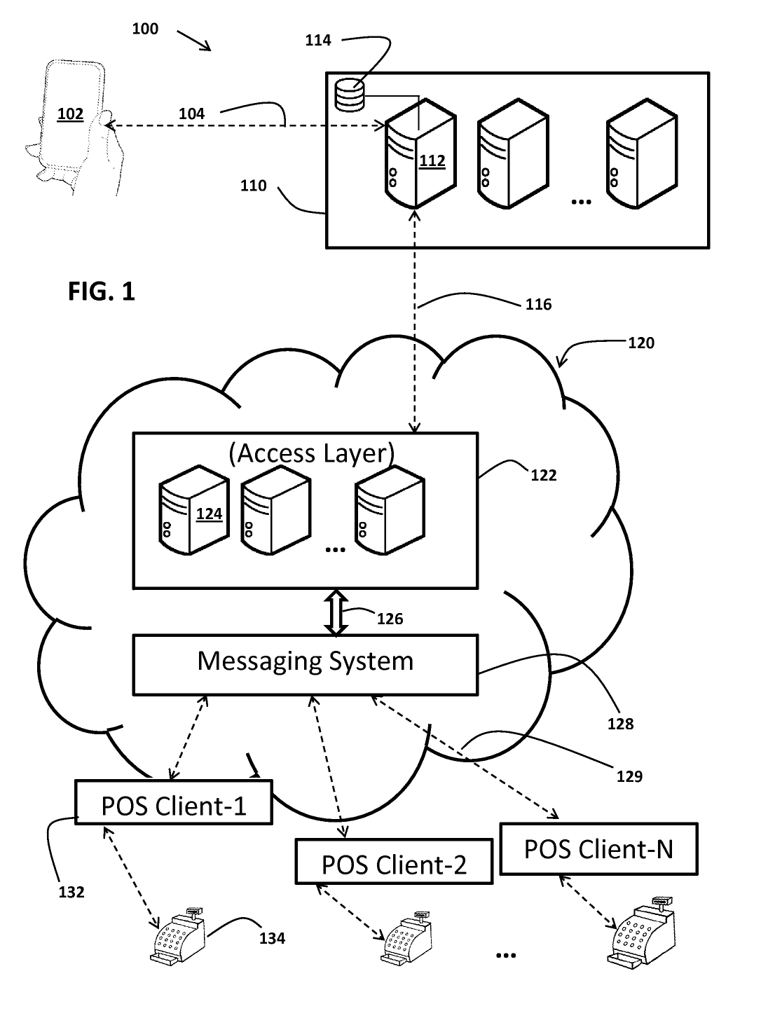

Referring now to the drawings wherein the showings are for purposes of illustrating embodiments of the invention only and not for purposes of limiting the same, FIG. 1 is a schematic diagram of an embodiment 100 including an Internet-enabled mobile computing device 102 in bidirectional communication 104 with at least one remote server 112 comprising a plurality of remote servers 110. The remote server 112 includes a database 114 which may include, without limitation, data identifying a subscriber, i.e. user of the mobile computing device 102. Such data may further include name and billing information of the subscriber, and may still further include payment credentials that may be communicated to a third party at the direction of the subscriber. The remote server 112 is shown in bidirectional communication 116 with a cloud-based 120 access layer 122. The access layer 122 comprises a plurality of networked servers 124. The access layer 122 communicates bidirectionally 126 with a cloud-based 120 messaging system 128. The messaging system 128 in turn communicates bidirectionally 129 with one or more point-of-sale clients 132, and finally the point-of-sale client 132 communicates bidirectionally 133 with a retail checkout system 134. Thus, messages may be passed back and forth between a mobile device 102 and the retail checkout system 134, and these messages may be regulated so that only current subscribers may use the system 100. Again, the nature of messages passed between the mobile computing device 102 and the retail checkout system 134 may vary and may include, without limitation, payment orders and/or payment credentials, price and item data, tab summaries, and order summaries, etc.

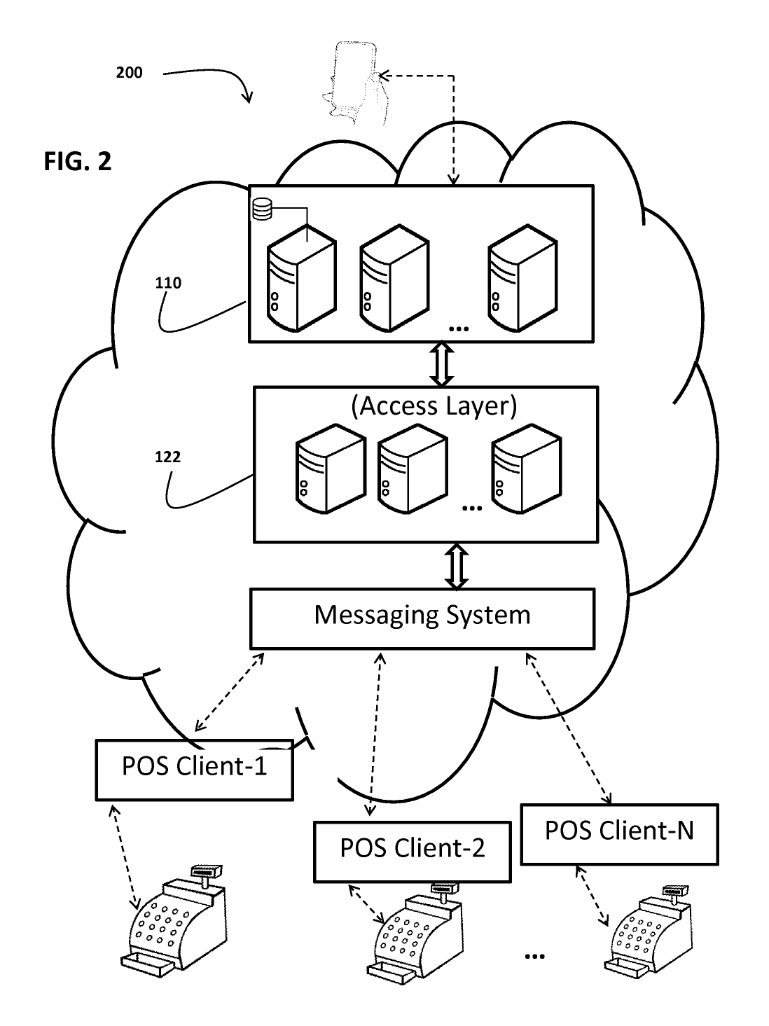

An embodiment 200 according to FIG. 2 comprises a plurality of remote servers 110 directly integrated with the access layer 122 in a cloud-based system. Although the illustration of FIG. 2 shows separate computers functioning as the remote servers 110 and the access layer 122, one skilled in the art will appreciate that remote server software and access layer software may coexist on the same computer, and may even comprise different aspects of the same computer program.

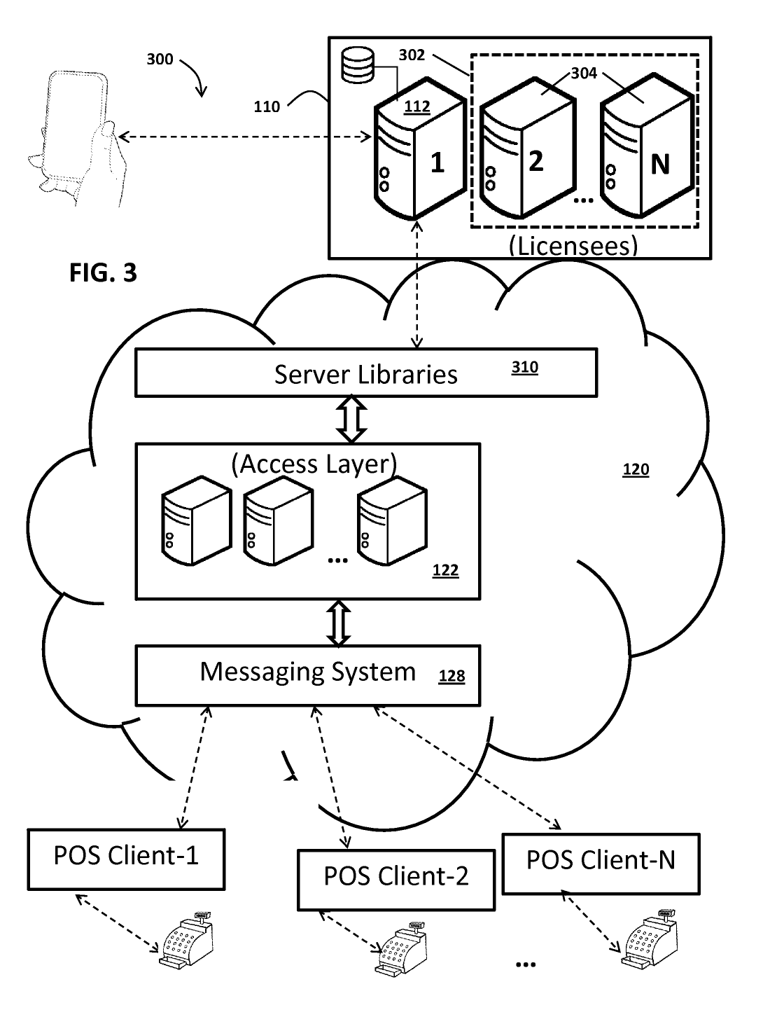

According to another embodiment 300 shown in FIG. 3, the plurality of remote servers 110 can comprise two different kinds or classes of servers. Although both classes may or may not function similarly, a first class 112 of remote server may be co-owned with the cloud based 120 access layer 122 and messaging systems 128, and thus would likely, although not necessarily, comprise compatible platforms capable of communicating with the cloud-based systems without further adaptation. A second class of remote servers 304, the plurality of which are referred to herein by reference number 302, may be separately owned by entities that license access to the cloud-based access layer 122 and messaging systems 128. Licensee servers 302 may or may not be compatible with the access layer 122 and messaging system 128. Thus, an access layer 122 according to this embodiment 300 may also include a set of server libraries 310 which enable licensee servers 304 to communicate with the access layer 122.

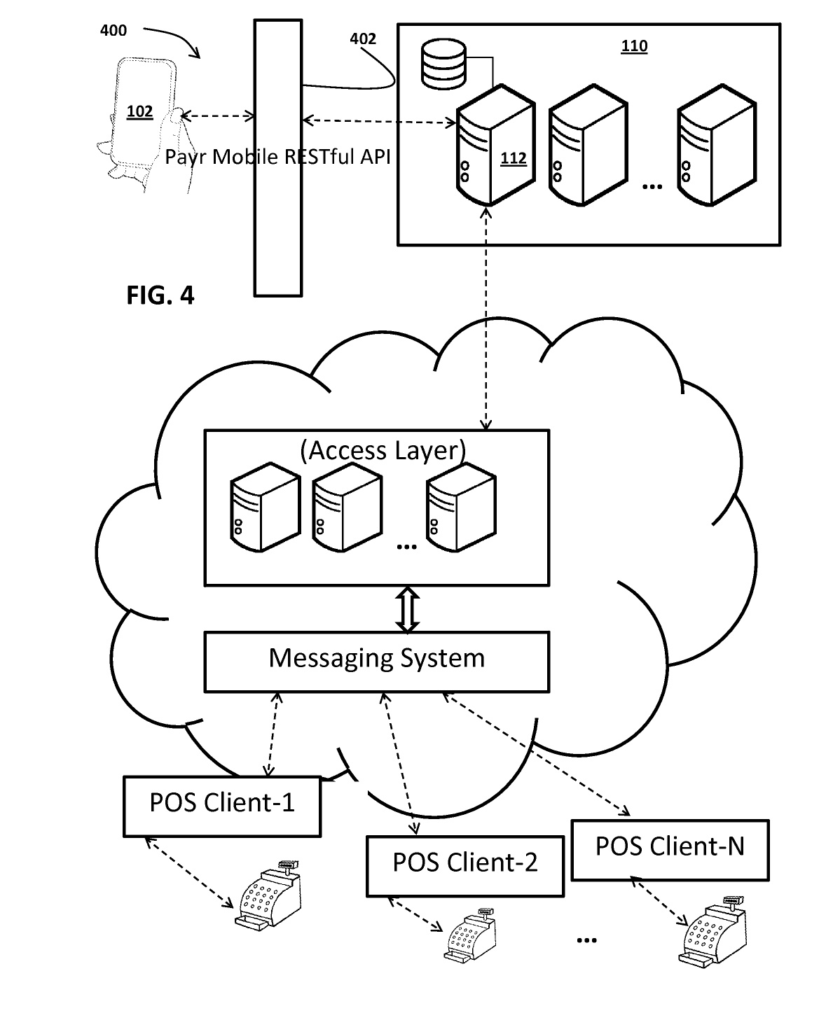

In a fourth embodiment 400 illustrated in FIG. 4 a mobile computing device 102 may communicate with a remote server 112 through an application programming interface (API) 402. According to the present embodiment 400, the API 402 conforms to the REST (Representational State Transfer) standard; however, the present invention is not limited to REST APIs and may include APIs that do not fully conform to the REST standard or conform to an alternative standard.

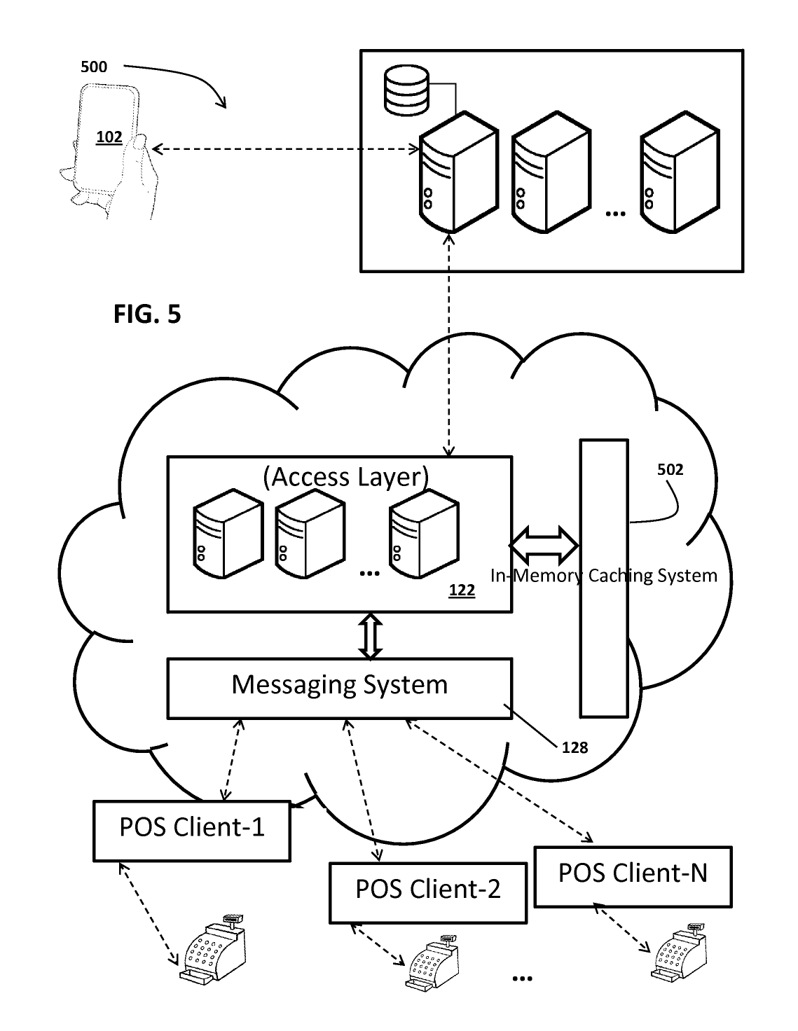

A fifth embodiment 500 is shown in FIG. 5 and illustrates the inclusion of an in-memory caching system 502. Such a caching system 502 may be helpful to improve system performance; however, caching is considered an optional feature and may not be necessary for achieving optimal performance. Some embodiments implementing a caching system 502 may use a system which associates data with a data key for storage purposes, e.g. an implementation based upon Redis. This may be a preferable mode of caching because of its inherent compatibility with pub/sub messaging systems. In practical application the messaging traffic handled by the access layer 122 may exceed the capacity of the messaging system 128, and may thus require that data and/or messages be temporarily stored, i.e. cached, until the messaging system is available to handle said excess traffic. Embodiments may thus temporarily record the excess traffic in memory using, for instance, a Redis-type caching system according to a set of predetermined caching and recall rules.

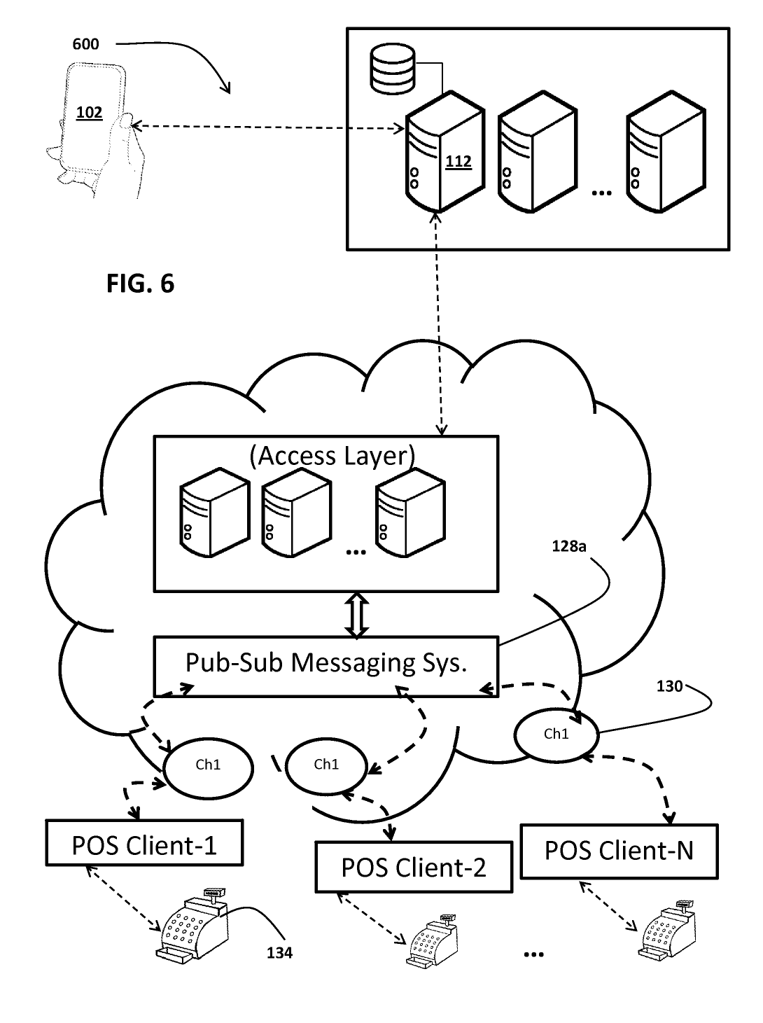

FIG. 6 illustrates a sixth embodiment 600, wherein the messaging system 128a functions according to a Publish-Subscribe Model (pub/sub). Typical pub/sub messaging systems allow users to publish content to a predetermined channel, and allow other users to subscribe to that channel. More particularly, a pub/sub system categorizes messages into classes, and subscribers determine what classes of messages they wish to receive. Thus, messages are not addressed to a particular user, but rather are published and made available to users who express an interest in a particular class of message. In the pub/sub implementation of FIG. 6, a consumer may use a mobile computing device 102 to send, for example, payment to a remote point-of-sale system 134 by instructing a remote server 112 to publish a payment message to a channel 130 defined by a predetermined set of classifications. Furthermore, the classifications may be unique to the point-of-sale system 134, and the point-of-sale system 134 may be known to subscribe to the channel 130. Thus, publishing a payment message or other message to the channel 130 may in effect relay the message to a predetermined point-of-sale system 134 similar to an addressed message. However, in some instances a given channel may be open for a plurality of related or unrelated entities to subscribe and thus receive the same message.

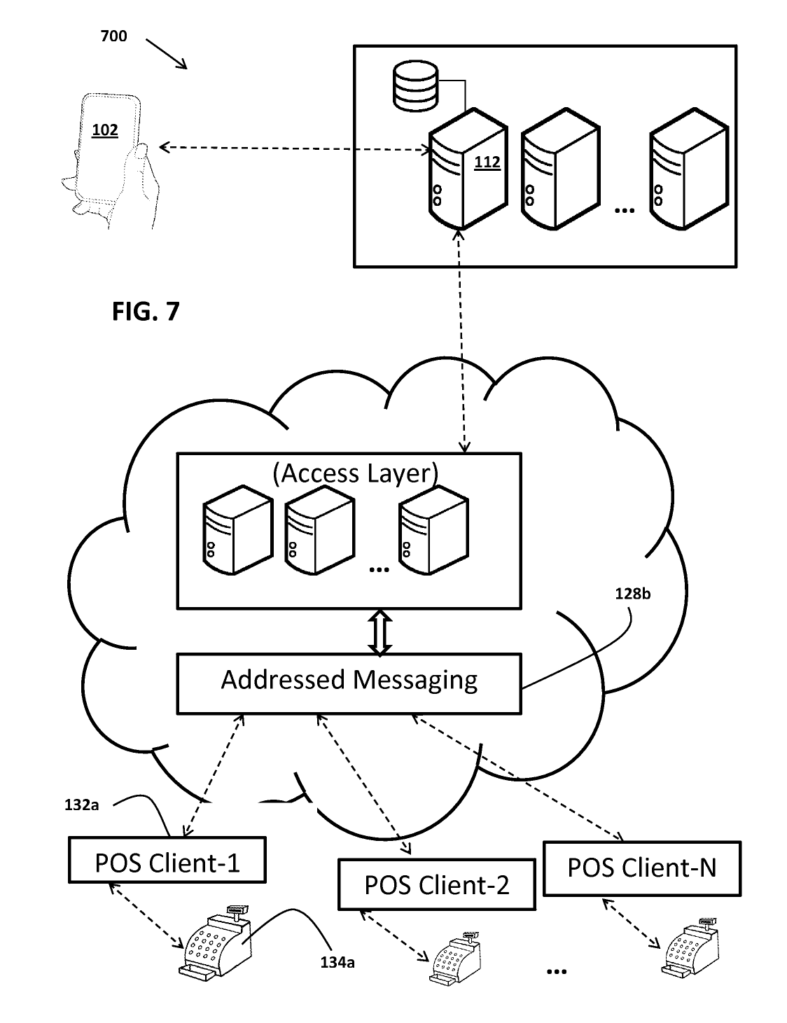

FIG. 7 illustrates an alternative embodiment 700 where the pub/sub messaging system of FIG. 6 is replaced with an addressed messaging system 128b. Generally, according to addressed messaging systems every message is coded for delivery to a predetermined recipient using a unique identifier such an alphanumeric string, an email address, an IP address, or a MAC address. Thus, payment messages may be transmitted from a sender having one unique address to a receiver having another unique address, and the recipient may use the sender's address, which is encoded in the message, to send a reply message. Accordingly, a message from a mobile computing device 102 may be sent specifically to, for instance, a retail checkout device 134a at a POS Client-1 132a.

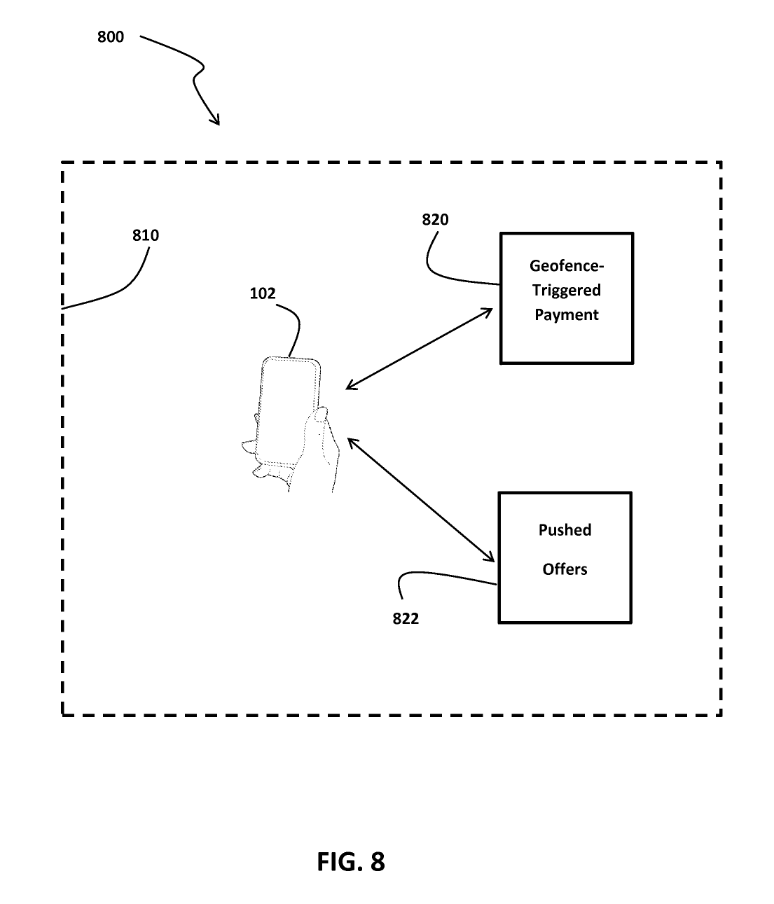

FIG. 8 illustrates optional features of a consumer-side frontend of an embodiment 800. As shown, the frontend is installed on a mobile computing device 102, which may be within the boundaries of a geofence 810. The geofence 810 may be operated and/or monitored by the owner of a hospitality establishment so that it knows when the mobile computing device 102 is on or near the premises. When the geofence detects the presence of the mobile computing device it may trigger a software component of the embodiment 800 to push offers and/or advertisements to the mobile computing device 102 which may be particularly relevant to the consumer due to his presence on-premises. In order to detect the presence of a mobile computing device 102, the embodiment 800 may include components and software for detecting beacon signals broadcasted by mobile devices such as, without limitation, low energy Bluetooth signals. One skilled in the art will appreciate that embodiments may be equipped to detect a variety of beacon signals. One specific example of such a low energy Bluetooth beacon signal is known as iBeacon technology which is owned by Apple, Inc. Additionally, the illustrated embodiment 800 includes a feature for automatically cashing out a consumer if the mobile device 102 leaves the boundaries of the geofence 810.

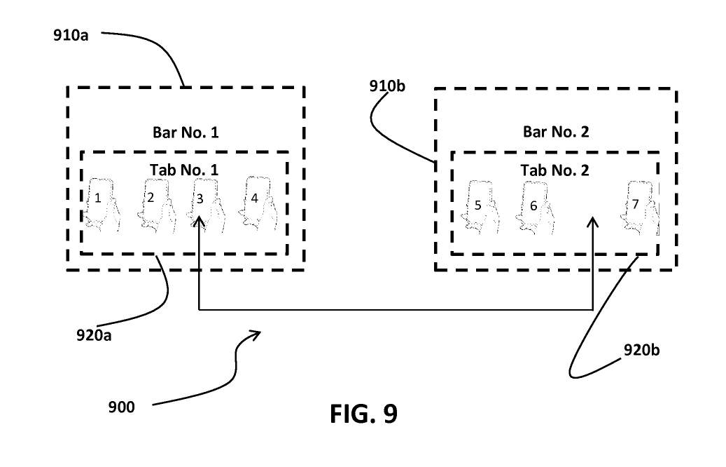

FIG. 9 illustrates optional features of a consumer-side frontend of an embodiment 900 wherein two different and unrelated hospitality establishments 910a, 910b are provided which both independently operate point-of-sale computer systems 134 (not shown) according to embodiments of the present invention. A set of consumers are represented by their mobile computing devices 1, 2, 3, 4, 5, 6, and 7. Consumers 1, 2, 3, and 4 are located in a first establishment 910a and are associated with a first tab 920a. Consumers 5, 6, and 7 are located a second establishment 910b and are associated with a second tab 920b. However, consumer 3 transits between the first and second establishments 910a, 910b and is a party to both tabs 920a, 920b simultaneously. Thus, according to this embodiment 900 consumer 3 is able to leave the second establishment 910b without automatically triggering the tab or his portion thereof to cash-out. This may be beneficial for any number of reasons including, without limitation, that consumer 3 wishes to pay the entire second tab 920b for consumers 5, 6, and 7 who have not finished their stay at the second establishment 910b, or perhaps consumer 3 intends to return. Thus, according this present embodiment 900, consumer 3 may pay his tab(s) at the time of his choosing, within certain predetermined restrictions. For instance, consumer 3 may be forced to pay at closing time. Furthermore, the consumer-side frontend according to the present embodiment 900 may be adapted to enable consumer 3 to pay multiple tabs simultaneously.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

Having thus described the invention, it is now claimed:

I/We claim:

1. A remote point-of-sale communication and payment system, comprising:
at least one application executable on a mobile computing device, wherein the at least one application is adapted to generate messages to selected remote point-of-sale computers, receive messages from the selected remote point-of-sale computers, and generate orders to transmit payment credentials to the selected remote point-of-sale computers;
at least one remote server adapted to receive the messages from the at least one application and relay the messages to a cloud-based messaging system, the at least one remote server being further adapted to receive the messages from the selected remote point-of-sale computers through the cloud-based messaging system and relay the messages to the at least one application; and the at least one remote server being still further adapted to receive payment orders from the at least one application and transmit corresponding payment credentials to the selected point-of-sale computers as messages through the cloud-based messaging system;
the cloud-based messaging system comprising: a plurality of networked computers defining an access layer operating on a predetermined platform, the access layer being adapted to receive messages from the at least one remote server and route the messages to predetermined point-of-sale computers, and the access layer being further adapted to receive messages from the predetermined point-of-sale computers and route the messages to the at least one application through the at least one remote server; and
the at least one remote point-of-sale computer including a point-of-sale client executable on the at least one point-of-sale computer, the point-of-sale client being adapted to receive messages through the messaging system of the access layer, take actions in response to the messages received, and send messages through the messaging system of the access layer to the at least one application.

2. The system of claim 1, wherein the at least one remote server comprises a plurality of remote servers each operating on arbitrary platforms.

3. The system of claim 2, wherein the cloud-based messaging system further comprises a set of server libraries adapted to enable communications between each of the plurality of remote servers operating on arbitrary platforms and the access layer operating on a predetermined platform.

4. The system of claim 1, further comprising an application programming interface, wherein the at least one remote server is adapted to communicate with the at least one application through the application programming interface.

5. The system of claim 1, wherein the at least one remote server further comprises a customer database containing one or more of customer-identifying information, customer payment credentials, customer subscription information, or system usage information of a user.

6. The system of claim 1, wherein the cloud-based messaging system comprises a pub/sub messaging system adapted to publish messages to one or more predetermined channels, and the cloud-based messaging system being further adapted to enable the access layer and/or the at least one point-of-sale client to subscribe to the one or more predetermined channels.

7. The system of claim 1, wherein the cloud-based messaging system routes addressed messages to predetermined addressee recipients.

8. The system of claim 1, wherein the at least one point-of-sale client further comprises a cash register program adapted to interact with and communicate with the access layer through the messaging system.

9. The system of claim 1, wherein the at least one point-of-sale client is adapted to receive messages from the access layer, translate the messages into a form readable by the cash register program, and transmit the messages to the cash register program; and the point-of-sale client being further adapted to receive messages from the cash register program, translate the messages into a form readable by the access layer, and transmit the messages to the access layer.

10. A remote point-of-sale communication and payment system, comprising:
a cloud-based messaging system comprising: a plurality of networked computers defining an access layer operating on a predetermined platform, the access layer being adapted to receive messages from at least one remote server and route the messages to predetermined point-of-sale computers, and the access layer being further adapted to receive messages from the predetermined point-of-sale computers and route the messages to at least one consumer-side application through the at least one remote server; and
the at least one remote point-of-sale computer including a point-of-sale client executable on the at least one point-of-sale computer, the point-of-sale client being adapted to receive messages through the messaging system of the access layer, take actions in response to the messages received, and send messages through the messaging system of the access layer to the at least one consumer-side application.

11. The system of claim 10, wherein the cloud-based messaging system further comprises a set of server libraries adapted to enable communications between the access layer and each of the plurality of remote servers, wherein the remote servers each operate on arbitrary platforms and the access layer operates on a predetermined platform.

12. The system of claim 10, wherein the cloud-based messaging system comprises a pub/sub messaging system adapted to publish messages to one or more predetermined channels, and the cloud-based messaging system being further adapted to enable the access layer and/or the at least one point-of-sale client to subscribe to the one or more predetermined channels.

13. The system of claim 10, wherein the cloud-based messaging system routes addressed messages to predetermined addressee recipients.

14. The system of claim 10, wherein the at least one point-of-sale client further comprises a cash register program adapted to interact with and communicate with the access layer through the messaging system.

15. The system of claim 10, wherein the at least one point-of-sale client is adapted to receive messages from the access layer, translate the messages into a form readable by the cash register program, and transmit the messages to the cash register program; and the point-of-sale client being further adapted to receive messages from the cash register program, translate the messages into a form readable by the access layer, and transmit the messages to the access layer.

16. A remote point-of-sale communication and payment system, comprising:
at least one application executable on a mobile computing device, wherein the at least one application is adapted to generate messages to selected remote point-of-sale computers, receive messages from the selected remote point-of-sale computers, and generate orders to transmit payment credentials to the selected remote point-of-sale computers;
at least one remote server adapted to receive the messages from the at least one application and relay the messages to a cloud-based messaging system, the at least one remote server being further adapted to receive the messages from the selected remote point-of-sale computers through the cloud-based messaging system and relay the messages to the at least one application; and, the at least one remote server being still further adapted to receive payment orders from the at least one application and transmit corresponding payment credentials to the selected point-of-sale computers as messages through the cloud-based messaging system, wherein the at least one remote server comprises a plurality of remote servers each operating on arbitrary platforms, and wherein the cloud-based messaging system further comprises a set of server libraries adapted to enable communications between each of the plurality of remote servers operating on arbitrary platforms and the access layer operating on a predetermined platform;
an application programming interface, wherein the at least one remote server is adapted to communicate with the at least one application through the application programming interface;
the cloud-based messaging system comprising: a plurality of networked computers defining an access layer operating on a predetermined platform, the access layer being adapted to receive messages from the at least one remote server and route the messages to predetermined point-of-sale computers, and the access layer being further adapted to receive messages from the predetermined point-of-sale computers and route the messages to the at least one application through the at least one remote server; and
the at least one remote point-of-sale computer including a point-of-sale client executable on the at least one point-of-sale computer, the point-of-sale client being adapted to receive messages through the messaging system of the access layer, take actions in response to the messages received, and send messages through the messaging system of the access layer to the at least one application.

17. The system of claim 16, wherein the cloud-based messaging system comprises a pub/sub messaging system adapted to publish messages to one or more predetermined channels, and the cloud-based messaging system being further adapted to enable the access layer and/or the at least one point-of-sale client to subscribe to the one or more predetermined channels.

18. The system of claim 16, wherein the cloud-based messaging system routes addressed messages to predetermined addressee recipients.

19. The system of claim 16, wherein the at least one point-of-sale client further comprises a cash register program adapted to interact with and communicate with the access layer through the messaging system.

20. The system of claim 16, wherein the at least one point-of-sale client is adapted to receive messages from the access layer, translate the messages into a form readable by the cash register program, and transmit the messages to the cash register program; and the point-of-sale client being further adapted to receive messages from the cash register program, translate the messages into a form readable by the access layer, and transmit the messages to the access layer.
